(19) United States
(12) Patent Application Publication
(10) Pub. No.: US 2011/0204627 A1
(43) Pub. Date: Aug. 25, 2011

(54) Electrical generating device with potential energy of water or fluid

(76) Inventors: Fu Hung Ho, Taichung Hsien (TW); Ming Jung Kao, Taichung Hsien (TW)

(21) Appl. No.: 12/660,217

(22) Filed: Feb. 23, 2010

(51) Int. Cl. F03B 13/06; H02P 9/04; H02K 53/00

(52) U.S. Cl. 290/43; 290/54; 415/916

(57) ABSTRACT

An electrical generating device includes one or more ram water pumps for pumping water from a lower water reservoir into an upper water tower, a water paddling device having a rotatable housing located below the water tower and coupled to an electric generator to generate an electrical energy, and a control device having a casing for directing the water to rotate the housing and having a pivotal valve member to control a flowing of the water through the casing and into the housing, an adjusting element is attached to the casing and engaged with the valve member for pivoting and adjusting the valve member relative to the casing and to control the water to flow into the housing.

### BACKGROUND OF THE INVENTION

1. Field of the Invention

The present invention relates to an electrical generating device, and more particularly to an electrical generating device for generating electrical energy with the potential energy of the water supported on a high position and for allowing the electric generating device to be available and to be used for the house buildings and/or for the house families.

2. Description of the Prior Art

Typical hydraulic electrical generating devices comprise a structure for utilizing or employing the water flowing or the hydraulic energy to generate the electrical energy. However, the water flowing or the hydraulic energy is not available for normal house buildings, such that the typical electrical generating devices are not available for the normal house buildings, and may not be provided for generating the electrical energy for the normal house families.

For our house buildings, one or more water towers are required to be disposed and supported on the higher position of the house buildings, and one or more water pumps are required to be provided for pumping the water upwardly to the water towers. However, a large amount of electrical energy is required to be provided for energizing and actuating or operating the water pumps, and the highly supported water may not be used to generate the electrical energy.

The present invention has arisen to mitigate and/or obviate the afore-described disadvantages of the conventional electrical generating devices.

### SUMMARY OF THE INVENTION

The primary objective of the present invention is to provide an electrical generating device for generating electrical energy with the potential energy of the water supported on a high position.

The other objective of the present invention is to provide an electrical generating device for allowing the electric generating device to be available and to be used for the house buildings and/or for the house families.

The further objective of the present invention is to provide an electrical generating device including an adjusting or controlling device for adjusting the water flowing quantity.

The still further objective of the present invention is to provide an electrical generating device including a number of curved blades disposed in a housing of a water paddling device for allowing the housing of the water paddling device to be rotated or driven by the water or the fluid from the higher water tower.

In accordance with one aspect of the invention, there is provided an electrical generating device comprising a support including a water reservoir for receiving and containing water, a water tower disposed on the support and located above the water reservoir for receiving the water, and including an outlet tube, at least one ram water pump provided for pumping the water from the water reservoir upwardly into the water tower, a hydraulic energy converting device including a water paddling device having a housing rotatably mounted to the support with a spindle and located below the water tower, an electric generator coupled to the spindle for allowing the electric generator to be rotated and driven by the spindle and the water paddling device, in order to generate an electrical energy, and a control device including a casing coupled to a lower portion of the outlet tube and directed to the housing of the water paddling device for supplying the water to move the housing of the water paddling device and to rotate the spindle and for controlling the water to flow out of the water tower and to flow into the housing of the water paddling device, and including a valve member pivotally disposed in the casing with a pivot axle for allowing the valve member to be pivoted relative to the casing in order to control a flowing of the water through the casing and into the housing, and including an adjusting element attached to the casing and engaged with the valve member for pivoting and adjusting the valve member relative to the casing in order to control the opening size or dimension or area of the casing and so as to control the water flowing speed or quantity into or through the casing.

The adjusting element is a screw threaded to the casing and movable relative to the casing to selectively engage with the valve member. The casing includes a curved lower portion having a curvature similar to that of the housing of the water paddling device for engaging with the housing.

The support includes a water receptacle disposed below the water reservoir and having a discharging pipe for selectively discharging and supplying the water upwardly into the water reservoir.

The water paddling device includes a number of curved blades disposed in the housing and arranged around the spindle. The water paddling device includes a number of weights equally disposed in the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a front plan schematic view of an electrical generating device in accordance with the present invention;

FIG. 2 is a side plan schematic view of the electrical generating device; and

FIG. 3 is an enlarged partial side plan schematic view illustrating the operation of the electrical generating device.

### DETAILED DESCRIPTION OF THE PREFERRED EMBODIMENT

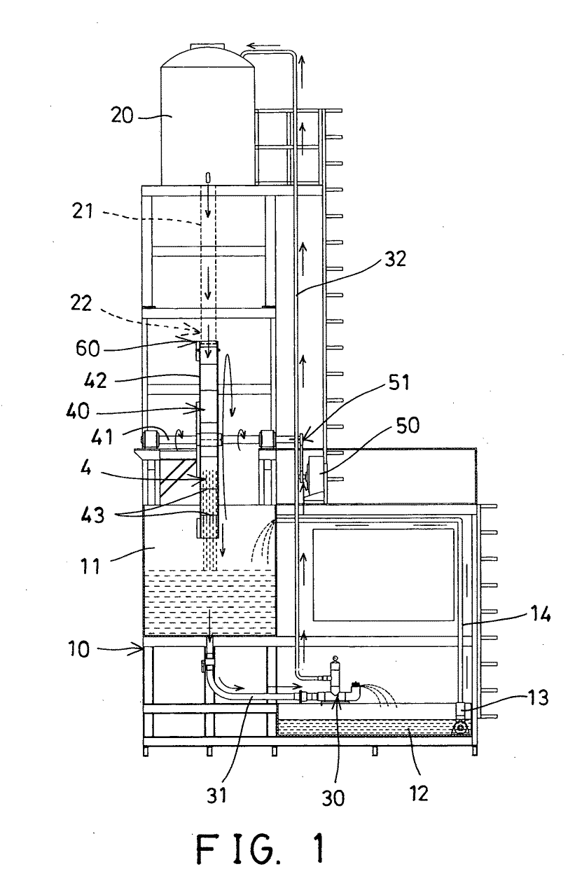

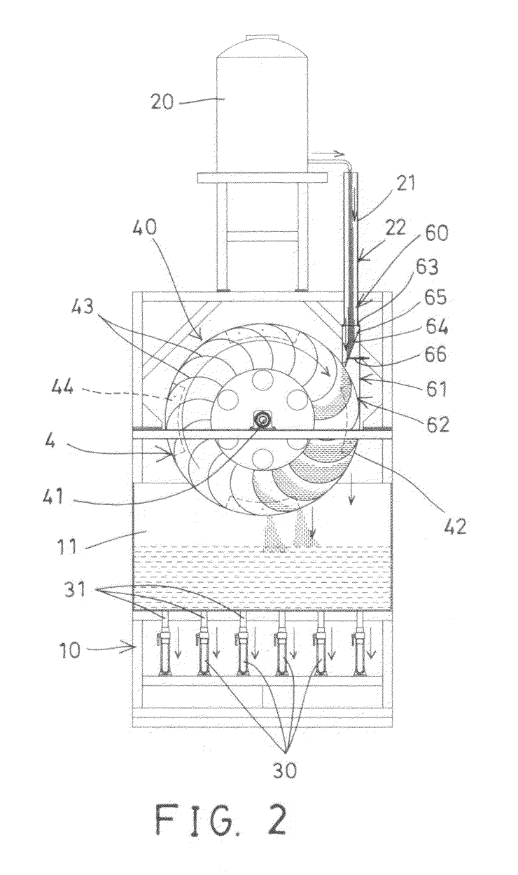

Referring to the drawings, and initially to FIGS. 1-2, an electrical generating device in accordance with the present invention comprises a column or machine body or support 10 including a water reservoir 11 disposed and supported on the middle or lower position of the support 10 for receiving or containing the water or the other fluid therein, and including a water receptacle 12 disposed and supported slightly below the water reservoir 11 for receiving or containing the water or the other fluid therein, and the water receptacle 12 includes a discharge port or water elevating device or ram water pump or water pumping member 13 connected or coupled to the water reservoir 11 with a discharging pipe 14 for selectively discharging or supplying the water or the fluid upwardly into the water reservoir 11.

A water tower 20 is disposed or mounted and supported on the higher position of the support 10 and located above the water reservoir 11, and includes an outlet tube 21 for supplying the water or the fluid downwardly into a water wheel or paddling device 40 of a hydraulic energy converting device 4. One or more (such as six, FIG. 2) water pumps 30, such as the ram water pumps 30 are located and attached or mounted above the water receptacle 12 and provided for pumping or forcing the water or the fluid upwardly to the water tower 20 without the electrical energy. For example, the ram water pumps 30 each include an inlet pipe 31 disposed and coupled to the water reservoir 11 for receiving the water or the fluid from the water reservoir 11, and each include an outlet pipe 32 disposed and directed or coupled to the water tower 20 for selectively directing or supplying the water or the fluid into the water tower 20 without the electrical energy.

The above-described ram water pumps 30 are typical and will not be described in further details, and an amount of the water or the fluid may flow out of the ram water pumps 30 while in use or when the ram water pumps 30 are actuated or operated, and the water or the fluid from the ram water pumps 30 may flow into the water receptacle 12, and may then be forced or pumped upwardly into the water reservoir 11, and the water or the fluid received or contained in the water tower 20 may be provided for generating an electrical energy with the potential energy of the water or the fluid that is disposed or supported on a higher position, which will be described in further details hereinafter.

The water paddling device 40 of the hydraulic energy converting device 4 includes one or more side walls or an outer housing 42 pivotally or rotatably attached or mounted onto the support 10 with a spindle 41, and includes a number of curved water drawing or scooping members or paddles or blades 43 disposed or mounted in the housing 42 and arranged around the spindle 41 and equally spaced from each other. For example, as shown in FIG. 2, the water paddling device 40 includes eighteen (18) equally spaced and curved blades 43 disposed or mounted in the housing 42 for receiving the water or the fluid from the water tower 20 and for allowing the water paddling device 40 to be rotated or driven by the water or the fluid from the water tower 20. The water paddling device 40 may further include one or more (such as four) weights 44 equally disposed or mounted in the housing 42 for balancing purposes.

The electrical generating device in accordance with the present invention further comprises one or more electric generators 50 (FIG. 1) disposed beside the spindle 41 and directly meshed or engaged with the spindle 41, or coupled to the spindle 41 with reduction gearings, change gears or change gear boxes or coupling devices 51 for allowing the electric generators 50 to be rotated or driven or actuated by the spindle 41 of the water paddling device 40, in order to generate the electrical energy, and/or to store or control the electrical energy, and for suitably supplying the electrical energy to energize and actuate or operate the other electrical facilities or appliances (not shown).

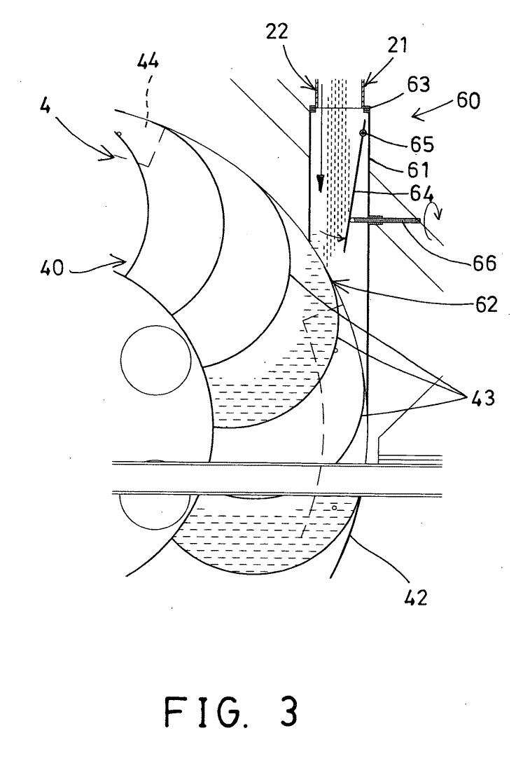

As best shown in FIGS. 2 and 3, a control device 60 may further be provided and coupled to the outlet tube 21 of the water tower 20, such as attached or mounted or coupled to the lower portion 22 of the outlet tube 21 for controlling the water or the fluid to selectively flow out of the water tower 20, and includes a casing 61 attached or mounted or coupled to the lower portion 22 of the outlet tube 21, and the casing 61 includes a curved lower portion 62 having a curvature similar to that of the housing 42 of the water paddling device 40 for snugly fitting or engaging with the corresponding outer curvature of the housing 42 and thus for suitably guiding or directing the water into the curved blades 43 of the housing 42 and for rotating the water paddling device 40 relative to the spindle 41 or the support 10.

It is preferable that the control device 60 includes a gasket or washer or sealing ring or other sealing member 63 disposed or attached or mounted between the lower portion 22 of the outlet tube 21 and the casing 61 for making a water or air tight seal between the outlet tube 21 and the casing 61 and for preventing the water from flowing out of the outlet tube 21 and the casing 61. The control device 60 further includes a valve member 64 disposed or engaged within the casing 61 and pivotally or rotatably attached or mounted and supported in the casing 61 with a pivot axle 65 for allowing the valve member 64 to be pivoted or rotated relative to the casing 61 and/or the support 10 in order to control the opening size or dimension or area of the casing 61 and so as to control the water flowing quantity through the casing 61 and into the curved blades 43 of the housing 42.

The control device 60 further includes a screw threading or adjusting element 66 threaded or attached or mounted to the casing 61 and movable relative to the casing 61 to selectively engage with the valve member 64 for pivoting or rotating the valve member 64 relative to the casing 61 and/or the support 10 in order to control the opening size or dimension or area of the casing 61 and so as to control the water flowing speed or quantity into or through the casing 61 and into the curved blades 43 of the housing 42, and thus to control the rotational speed of the housing 42 of the water paddling device 40 by the downwardly flowing water in order to control the electrical energy generating function or efficiency of the electric generators 50.

In operation, as shown in FIGS. 2 and 3, the water flowing out of the water tower 20 and flowing through the outlet tube 21 is directed or supplied into the curved blades 43 of the housing 42, and the weight or the potential energy of the water or the fluid may move the blades 43 of the housing 42 downwardly or in one direction, such as clockwise as shown in FIGS. 2 and 3, and may move or rotate or actuate the electric generators 50 to generate the electrical energy with the weight or the potential energy of the water or the fluid supported on a higher position. The rotational speed of the spindle 41 and the electric generators 50 will be relatively greater when the valve member 64 is relatively opened relative to the casing 61 and/or the support 10, and will be relatively smaller or less when the valve member 64 is relatively narrowed or closed relative to the casing 61 and/or the support 10.

It is to be noted that the water pumps 30 may be provided for pumping the water upwardly to the water tower 20 without the electrical energy, and the electric generators 50 may be rotated or actuated to generate the electrical energy with the weight or the potential energy of the water or the fluid supported on a higher position. It is further to be noted that the ram water pumps 30 may also be provided and directly attached or mounted or supported in the water reservoir 11 for directly pumping or forcing the water or the fluid to flow upwardly from the water reservoir 11 to the water tower 20 without the electrical energy and without the water receptacle 12. The control device 60 may be used to control the water flowing quantity through the casing 61 and into the curved blades 43 of the housing 42 and to control the rotational speed of the housing 42 of the water paddling device 40 in order to control the electrical energy generating function or efficiency of the electric generators 50.

Accordingly, the electrical generating device may be provided for generating electrical energy with the potential energy of the water supported on a high position and for allowing the electric generating device to be mounted and available and to be used for the house buildings or house families.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electrical generating device comprising:
a support including a water reservoir for receiving and containing water,
a water tower disposed on said support and located above said water reservoir for receiving the water, and including an outlet tube,
at least one ram water pump provided for pumping the water from said water reservoir upwardly into said water tower,
a hydraulic energy converting device including a water paddling device having a housing rotatably mounted to said support with a spindle and located below said water tower,
an electric generator coupled to said spindle for allowing said electric generator to be rotated and driven by said spindle and said water paddling device, in order to generate an electrical energy, and
a control device including a casing coupled to a lower portion of said outlet tube and directed to said housing of said water paddling device for supplying the water to move said housing of said water paddling device and to rotate said spindle and for controlling the water to flow out of said water tower and to flow into said housing of said water paddling device, and including a valve member pivotally disposed in said casing with a pivot axle for allowing said valve member to be pivoted relative to said casing in order to control a flowing of the water through said casing and into said housing, and including an adjusting element attached to said casing and engaged with said valve member for pivoting and adjusting said valve member relative to said casing.

2. The electrical generating device as claimed in claim 1, wherein said adjusting element is a screw threaded to said casing and movable relative to said casing to selectively engage with said valve member.

3. The electrical generating device as claimed in claim 1, wherein said casing includes a curved lower portion having a curvature similar to that of said housing of said water paddling device for engaging with said housing.

4. The electrical generating device as claimed in claim 1, wherein said support includes a water receptacle disposed below said water reservoir and having a discharging pipe for selectively discharging and supplying the water upwardly into said water reservoir.

5. The electrical generating device as claimed in claim 1, wherein said water paddling device includes a plurality of curved blades disposed in said housing and arranged around said spindle.

6. The electrical generating device as claimed in claim 1, wherein said water paddling device includes a plurality of weights equally disposed in said housing.

7. An electrical generating device comprising:
a support including a water reservoir for receiving and containing water,
a water tower disposed on said support and located above said water reservoir for receiving the water, and including an outlet tube,
at least one ram water pump provided for pumping the water from said water reservoir upwardly into said water tower,
a water paddling device including a housing rotatably mounted to said support with a spindle and located below said water tower,
an electric generator coupled to said spindle for allowing said electric generator to be rotated and driven by said spindle and said water paddling device, in order to generate an electrical energy, and
a control device including a casing coupled to a lower portion of said outlet tube and directed to said housing of said water paddling device for supplying the water to move said housing of said water paddling device and to rotate said spindle and for controlling the water to flow out of said water tower and to flow into said housing of said water paddling device, and
said water paddling device including a plurality of curved blades disposed in said housing and arranged around said spindle.

8. The electrical generating device as claimed in claim 7, wherein said water paddling device includes a plurality of weights equally disposed in said housing.

9. The electrical generating device as claimed in claim 7, wherein said control device includes a valve member pivotally disposed in said casing with a pivot axle for allowing said valve member to be pivoted relative to said casing in order to control a flowing of the water through said casing and into said housing.

10. The electrical generating device as claimed in claim 9, wherein said control device includes an adjusting element attached to said casing and engaged with said valve member for pivoting and adjusting said valve member relative to said casing.

11. The electrical generating device as claimed in claim 7, wherein said casing of said control device includes a curved lower portion having a curvature similar to that of said housing of said water paddling device for engaging with said housing.
